(19) United States
(12) Patent Application Publication
(10) Pub. No.: US 2018/0257689 A1
(43) Pub. Date: Sep. 13, 2018

(54) METHOD AND SYSTEM FOR PEOPLE INTERACTION AND GUIDED CART THEREFOR

(71) Applicant: CELEBRAMOTION INC., TERREBONNE (CA)

(72) Inventor: GUY LEFEBVRE, TERREBONNE (CA)

(21) Appl. No.: 15/761,988

(22) PCT Filed: Sep. 29, 2016
(86) PCT No.: PCT/CA2016/051133

§ 371 Date: Mar. 21, 2018

Related U.S. Application Data
(60) Provisional application No. 62/236,352, filed on Oct. 2, 2015.

(51) Int. Cl. B62B 5/00; G05D 1/02

(52) U.S. Cl. CPC B62B 5/0063; G05D 1/0244; G05D 1/0263; G05D 2201/0212; G05D 1/0246; B62B 5/0069; G05D 2201/0211; G05D 1/0242

(57) ABSTRACT

A method for people interaction, the method comprising setting positions in a space; materializing a path along the positions; and guiding a mobile platform along the path. A combination, comprising a cart, a controller, and a guiding unit is provided wherein the guiding unit comprises sensors configured to detect a path laid in a space along a succession of positions; and wherein the controller sets a direction of the cart by acting on the guiding unit in response to signals from the sensors as the cart moves along the path.

### FIELD OF THE INVENTION

The present invention relates to people interaction. More specifically, the present invention is concerned with a method and a system for people interaction and a guided cart therefor.

### SUMMARY OF THE INVENTION

More specifically, in accordance with the present invention, there is provided a method for people interaction, comprising setting positions in a space; materializing a path along the positions; and guiding a mobile platform along the path.

There is further provided a combination, comprising a cart, a controller, and a guiding unit; wherein the guiding unit comprises sensors configured to detect a path laid in a space along a succession of positions; and wherein the controller sets a direction of the cart by acting on the guiding unit in response to signals from the sensors as the cart moves along the path.

There is further provided a cart, comprising a platform; a guiding unit configured to detect a path materialised in a space; and a controller; wherein the controller sets a direction of the cart by acting on the cart in response to signals from the guiding unit.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1A is a schematic view of a cart according to an embodiment of an aspect of the present invention;

FIG. 1B is a side view of the cart of FIG. 1A;

FIG. 2 shows a layout of a system according to an embodiment of an aspect of the present invention;

FIG. 3 shows a layout of a system according to an embodiment of an aspect of the present invention;

FIG. 4 shows a layout of a system according to an embodiment of an aspect of the present invention;

FIG. 5 is a schematical view of a cart going along a path according to an embodiment of an aspect of the present invention;

FIG. 6 is a schematical view of a cart going along a path according to an embodiment of an aspect of the present invention;

FIG. 7 is a schematical view of a cart going along a path according to an embodiment of an aspect of the present invention;

FIG. 8 is a schematical view of a cart going along a path according to an embodiment of an aspect of the present invention;

FIG. 9 is a schematical view of a cart going along a path according to an embodiment of an aspect of the present invention;

FIG. 10 is a schematical view of a cart going along a path according to an embodiment of an aspect of the present invention;

FIG. 11 is a schematical view of a cart going along a path according to an embodiment of an aspect of the present invention;

FIG. 12 is a schematical view of a cart going along a path according to an embodiment of an aspect of the present invention;

FIG. 13 is a schematical view of a cart going along a path according to an embodiment of an aspect of the present invention;

FIG. 14A is an elevation side view of a cart according to an embodiment of an aspect of the present invention;

FIG. 14B is a top plan view of the cart of FIG. 14A;

FIG. 14C is a side view of the cart of FIG. 14A in a folded position;

FIG. 15A illustrates a cart according to different embodiments of an aspect of the present invention;

FIG. 15B illustrates a cart according to different embodiments of an aspect of the present invention;

FIG. 15C illustrates a cart according to different embodiments of an aspect of the present invention;

FIG. 15D illustrates a cart according to different embodiments of an aspect of the present invention;

FIG. 16 illustrates a layout of a system according to an embodiment of an aspect of the present invention;

FIG. 17 schematically shows the cart of FIG. 14 going along a first path according to an embodiment of an aspect of the present invention;

FIG. 18 schematically shows the cart of FIG. 14 going along the first path according to an embodiment of an aspect of the present invention;

FIG. 19 schematically shows the cart of FIG. 14 going along the first path according to an embodiment of an aspect of the present invention;

FIG. 20 schematically shows the cart of FIG. 14 going along the first path according to an embodiment of an aspect of the present invention;

FIG. 21 schematically shows the cart of FIG. 14 going along the first path according to an embodiment of an aspect of the present invention;

FIG. 22 schematically shows the cart of FIG. 14 going along the first path according to an embodiment of an aspect of the present invention;

FIG. 23 schematically shows the cart of FIG. 14 going along the first path according to an embodiment of an aspect of the present invention;

FIG. 24 schematically shows the cart of FIG. 14 going along the first path according to an embodiment of an aspect of the present invention;

FIG. 25 schematically shows the cart of FIG. 14 going along the first path according to an embodiment of an aspect of the present invention;

FIG. 26 schematically shows the cart of FIG. 14 going along a second path according to an embodiment of an aspect of the present invention;

FIG. 27 schematically shows the cart of FIG. 14 going along the second path according to an embodiment of an aspect of the present invention;

FIG. 28 schematically shows the cart of FIG. 14 going along the second path according to an embodiment of an aspect of the present invention;

FIG. 29 schematically shows the cart of FIG. 14 going along the second path according to an embodiment of an aspect of the present invention;

FIG. 30 schematically shows the cart of FIG. 14 going along the second path according to an embodiment of an aspect of the present invention;

FIG. 31 schematically shows the cart of FIG. 14 going along the second path according to an embodiment of an aspect of the present invention;

FIG. 32 schematically shows the cart of FIG. 14 going along the second path according to an embodiment of an aspect of the present invention;

FIG. 33 schematically shows the cart of FIG. 14 going along the second path according to an embodiment of an aspect of the present invention;

FIG. 34 schematically shows the cart of FIG. 14 going along the second path according to an embodiment of an aspect of the present invention;

FIG. 35 schematically shows the cart of FIG. 14 going along the second path according to an embodiment of an aspect of the present invention; and

FIG. 36 is a table of activation of the sensors of the cart of FIGS. 14-35 according to an embodiment of an aspect of the present invention.

### DESCRIPTION OF EMBODIMENTS OF THE INVENTION

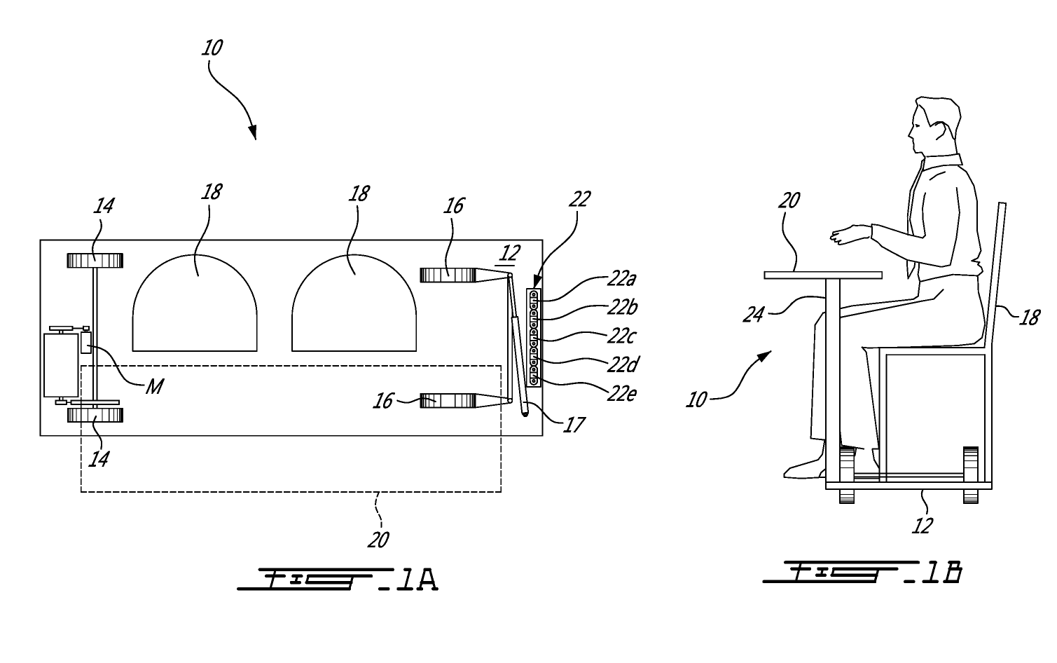

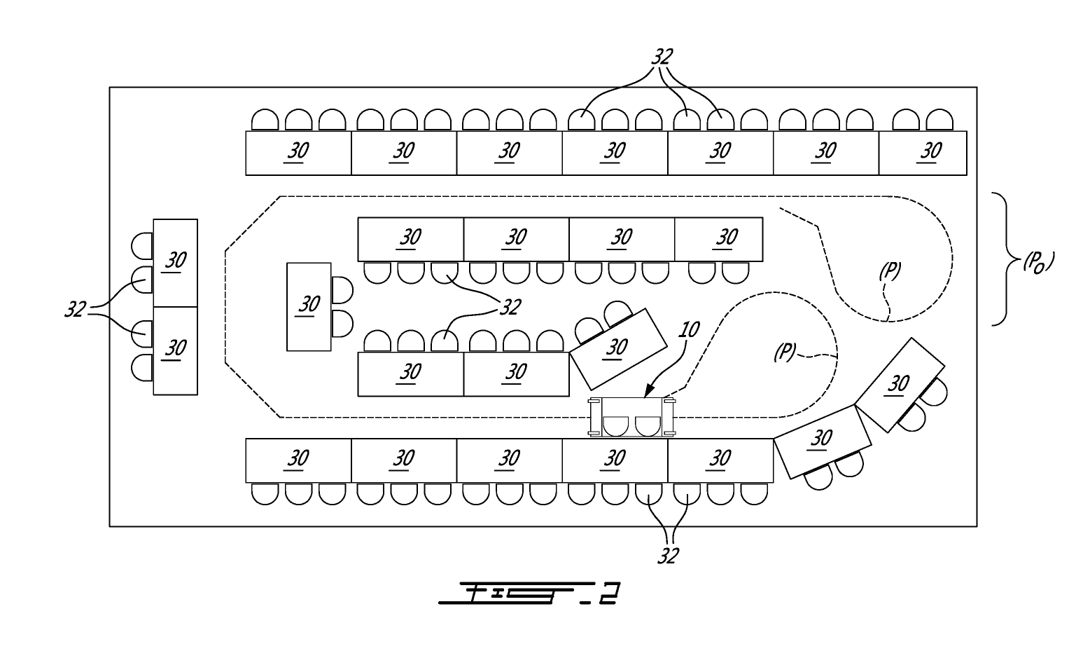

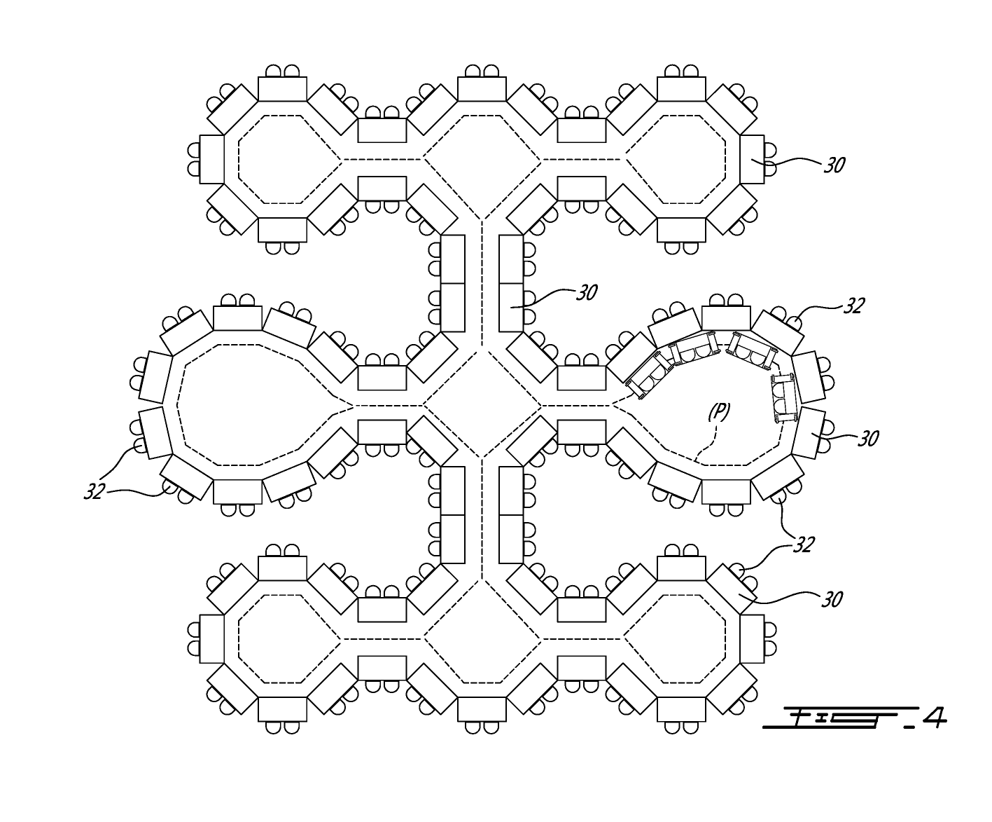

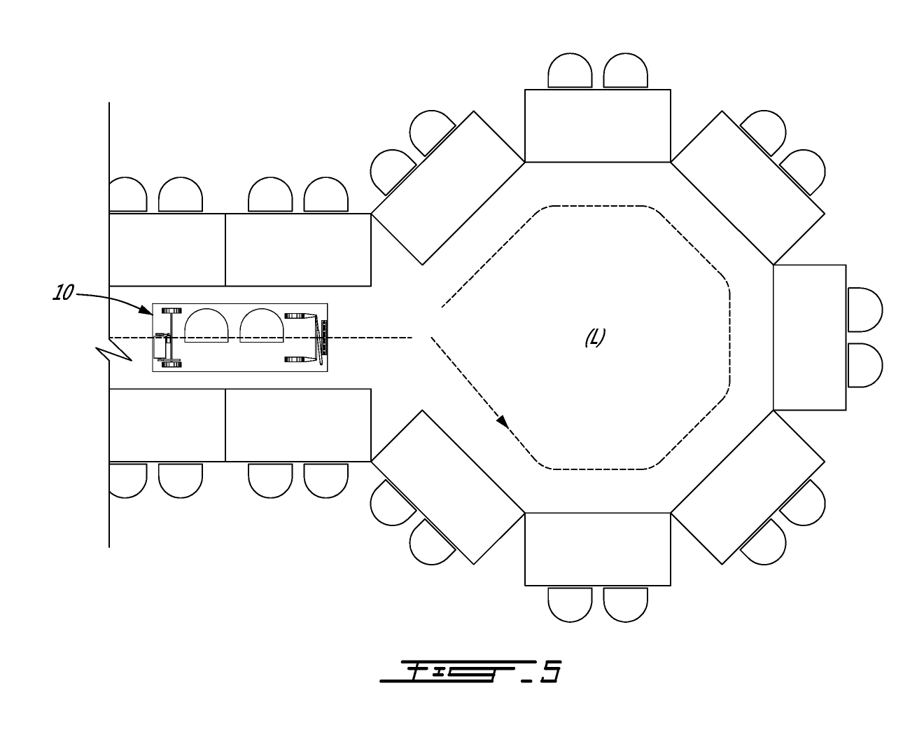

FIGS. 1-13 show a cart according to an embodiment of an aspect of the present invention.

The cart 10 comprises a platform 12, adapted to support at least one person for example, and comprising rear wheels 14 and front wheels 16 for example. At least one of the rear wheels 14 is motorised, and the front wheels 16 are provided with a deviation system such as a cylinder 17 for movements to the right and to the left as illustrated for example.

The front edge of the platform 12 comprises a line of sensors 22, as will be discussed hereinbelow. In the illustrated embodiment, the platform 12 supports at least one seat 18 in front of a table 20. As best seen in FIG. 1B, the table 20 may be supported by a foot 24 rising from the longitudinal edge of the platform 12.

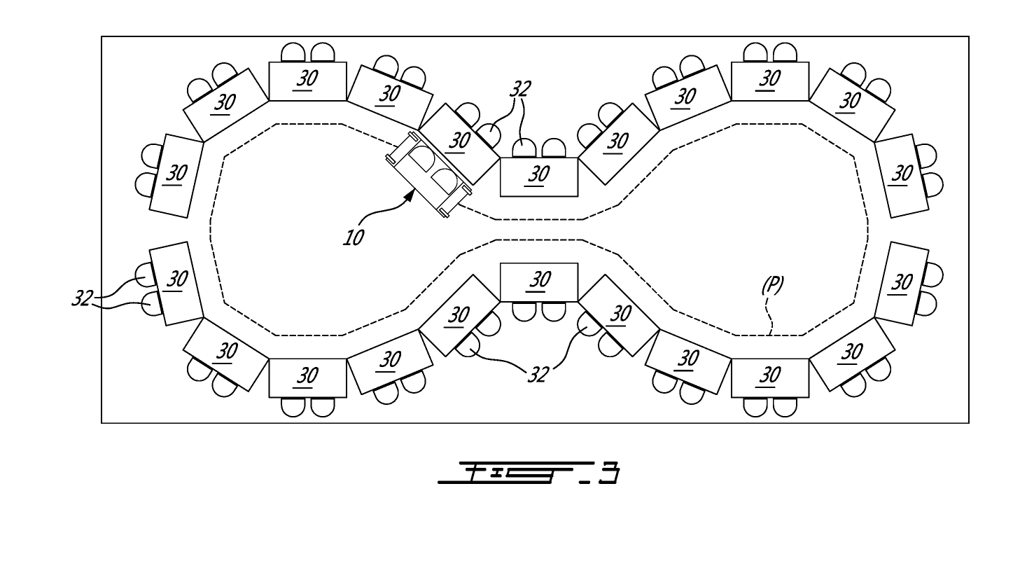

As illustrated in FIGS. 2 to 4 for example, according to an embodiment of an aspect of the present invention, a number of tables 30 and seats 32 are positioned along a path (P) in a space such as a room for example, so that the seats 32 are positioned facing the path (P) across respective tables 32.

The cart 10 is guided along the path (P) so that the at least one person carried thereon successively faces positions materialised by the tables 30 and the seats 32, i.e. the cart 10 successively carries the person thereon in a facing relationship with persons present at the tables 30. The platform, and in particular the table thereon, may be selected so that their size allows people carried thereon to be at a convivial distance from the persons sitting on an opposite table 30 as the cart goes by. The platform width may be selected so that this distance is minimized, thereby allowing the people on the platform and the people across the tables 30 they pass by to have easy interaction. Alternatively, or in combination, the height of the platform and/or of the table supported thereon may be selected so that the top surface of the table supported on the platform is slightly higher than the top surface of the tables 30 so that the table supported on the platform can overlap at least partially the tables 30 as the platform goes around the path (P). As a result, the width of the path (P) itself does not need to be as large as the width of the table supported on the platform.

The path (P) may be materialised on the ground of the space, i.e. on the floor of the room for example, by a black line for example, the sensors 22 then being cameras, so that the cart 10 is guided therealong by the cameras 22 as discussed hereinbelow.

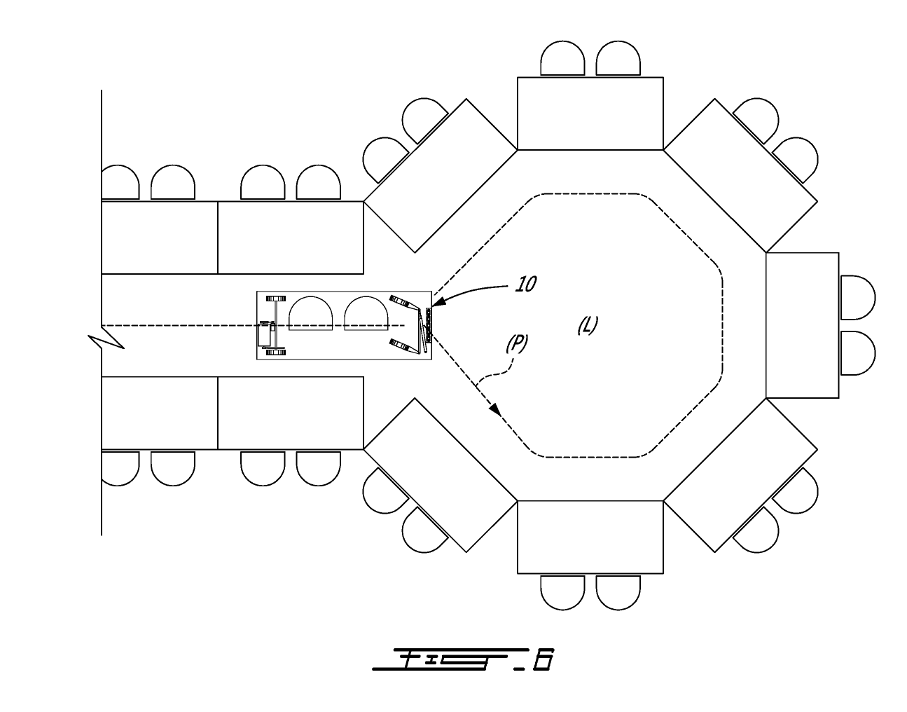

FIGS. 5 to 13 illustrate an example of a path (P) forming a loop (L), the cart 10, moving along the path (P), going once around the loop (L) (see arrow).

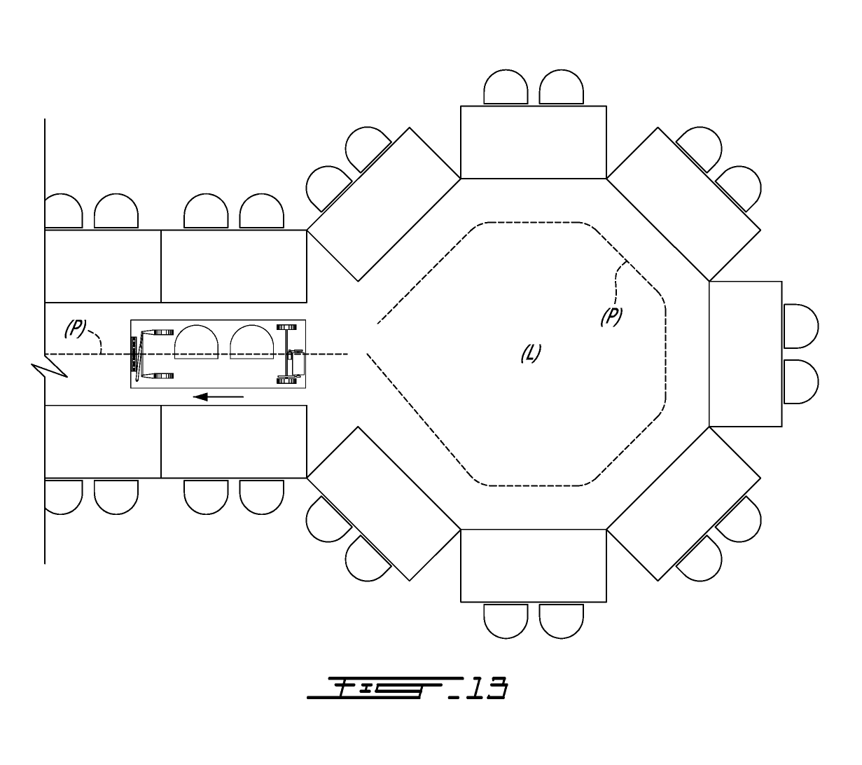

In the present embodiment, a line 22 of 5 sensors 22a-22e is used (see FIG. 1A). When the path (P) follows a straight line, the centre of the line of sensors 22 is aligned with the path (P), so that the middle sensor 22c detects the path (P) and sends a signal to the controller 13, which in response guides the cart 10 along the straight line by directing the front wheels along the straight line, as shown in FIGS. 5 and 13 for example.

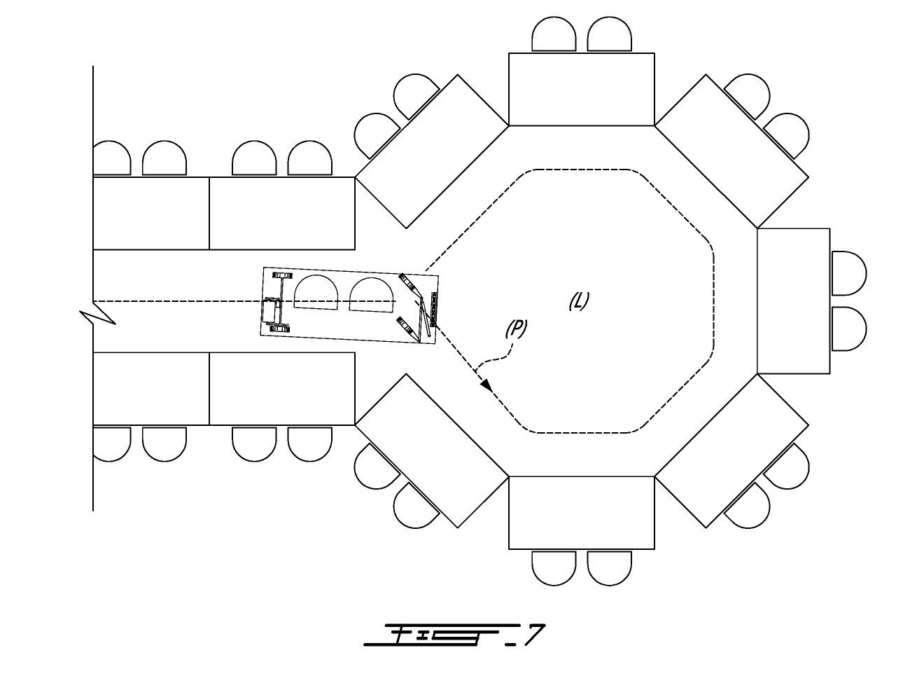

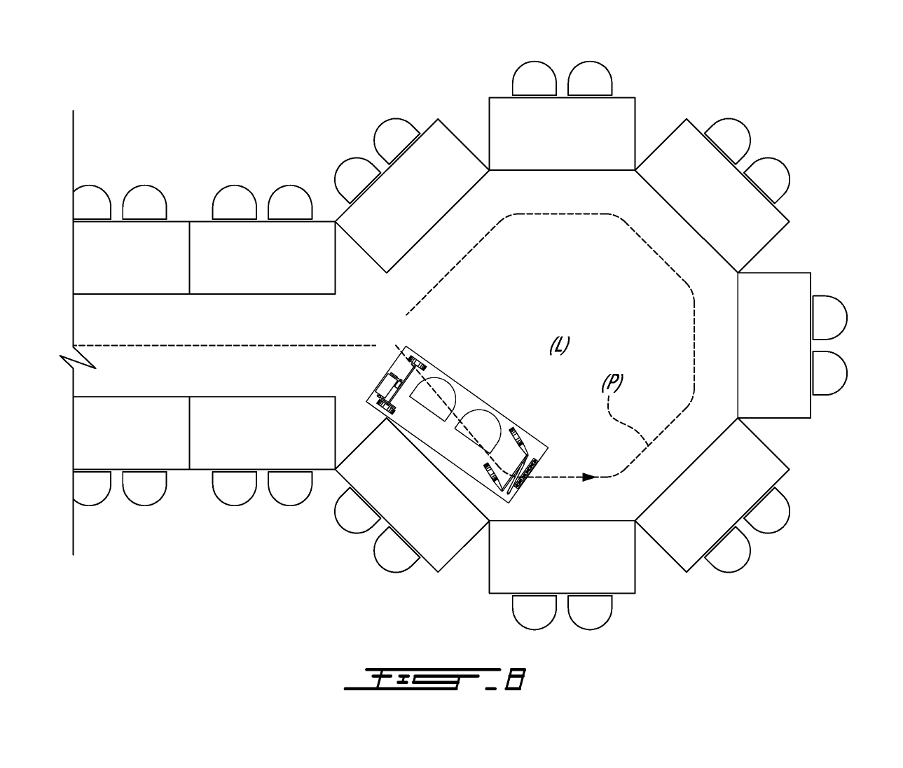

When the path (P) then goes to the right, only the first or the second sensors 22d and 22e to the right of the middle sensor 22c detect the path (P) and in response the controller 13 activates the cart 10 into steering to the right as shown in FIGS. 6-8 and 11-12 for example. In FIG. 6, the first sensor 22d to the right of the middle sensor 22c detects the path (P) and in response the controller 13 activates the cart 10 into steering at 22.5 degrees to the right, and in FIG. 7 the second sensor 22e to the right of the middle sensor 22c in turns detects the path (P) and in response the controller 13 activates the cart 10 into further steering at 45 degrees to the right for example, before the first sensor 22d to the right of the middle sensor 22c detects the path (P) again and the controller 13 in response activates the cart 10 into re-squaring to 22.5 degrees in FIG. 8.

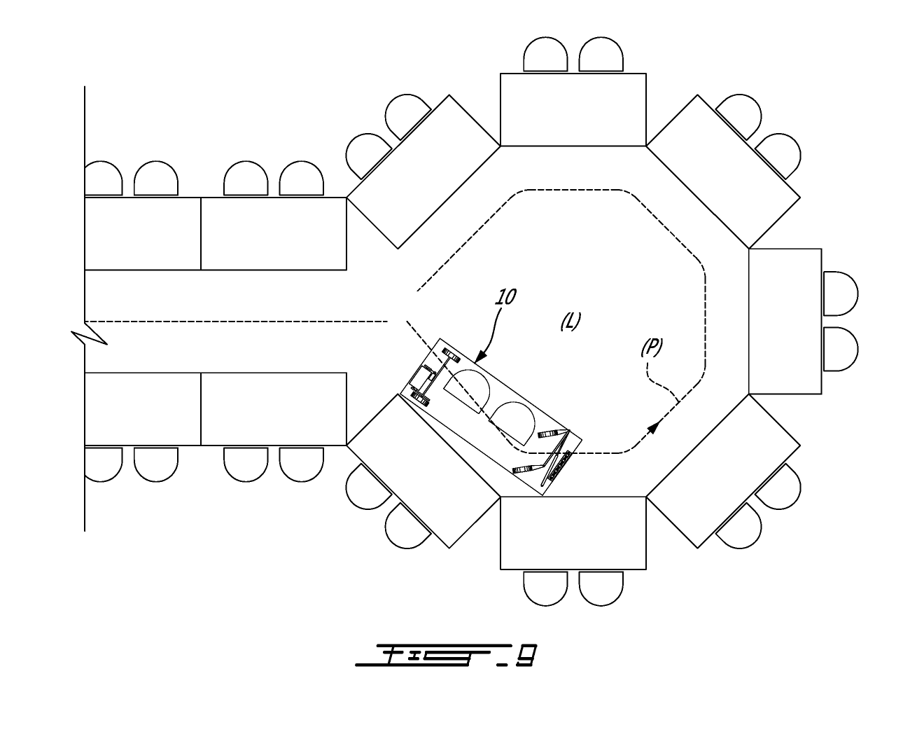

When the path (P) then goes to the left, only the first and second sensors 22b or 22a to the left of the middle sensor 22c detect the path (P) and the controller 13 in response activates the cart 10 into steering to the left. In FIG. 9 for example the second sensor 22a to the left of the middle sensor 22c detects the path (P) and the controller 13 in response activates the cart into steering left at 45 degrees for example.

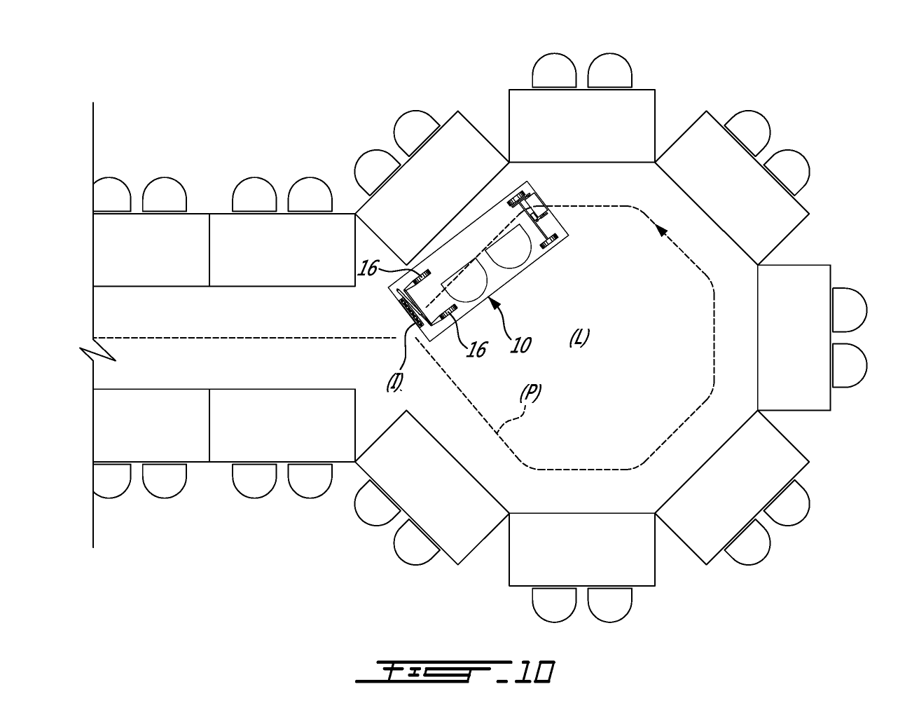

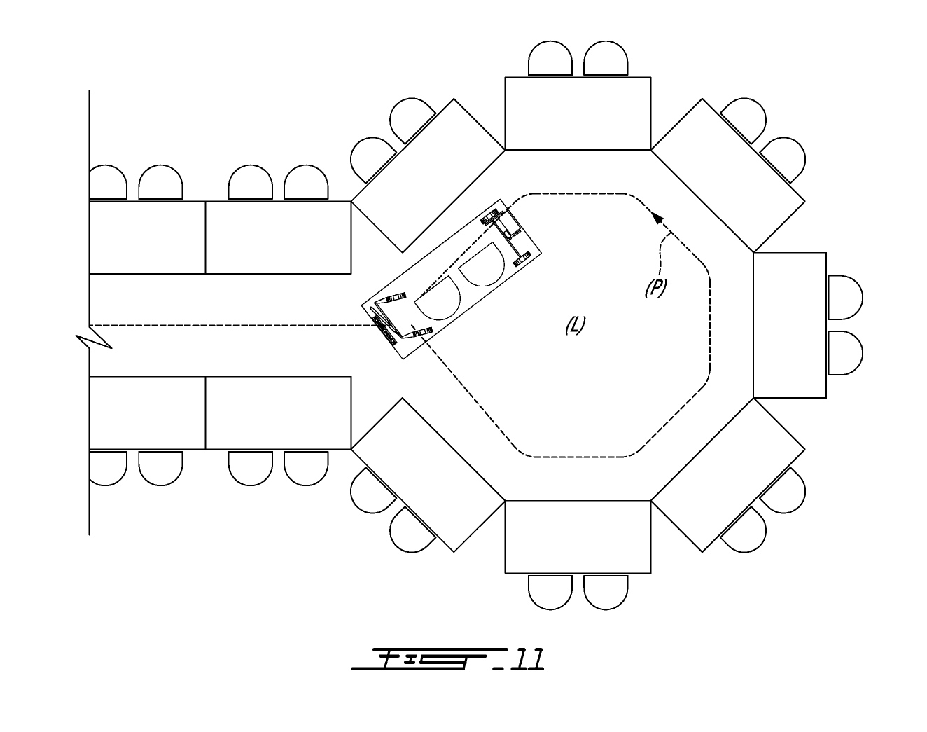

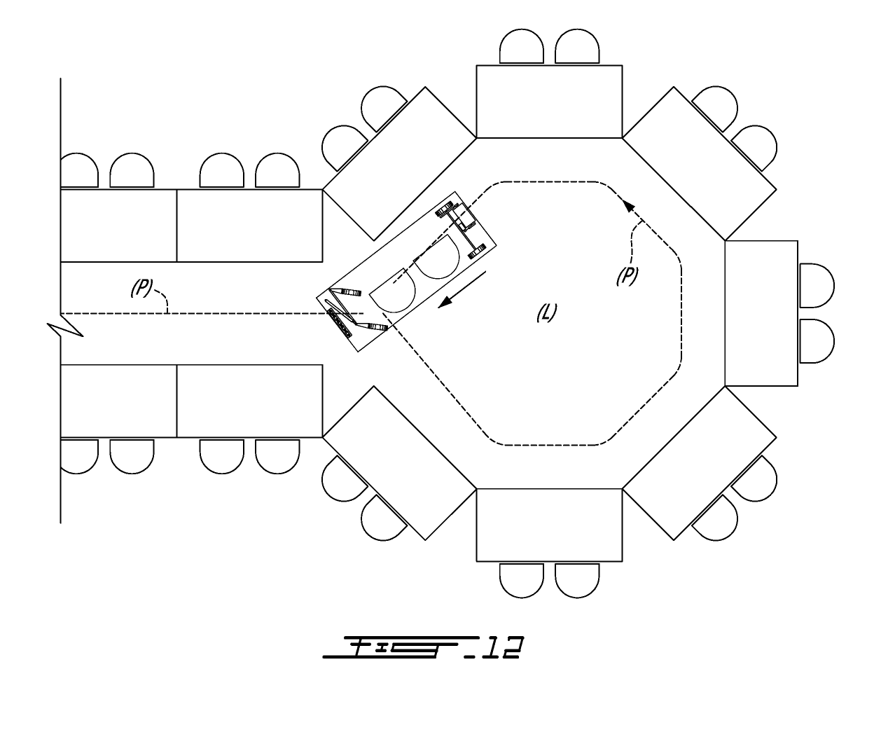

When the path (P) is discontinued, i.e. at an intersection (I) as illustrated for example in FIG. 10, the cart 10 retains the last configuration it was on and none of the sensors 22 is active until the cart 10 reaches a next portion of the path (P) again. As the next portion of the path (P), i.e. to exit the loop (L), goes to the right, only the first or the second sensors 22d and 22e to the right of the middle sensor 22c detect the path (P); in FIG. 11, the first sensor 22d to the right of the middle sensor 22c detects the path (P) and activates the cart 10 into steering to the right out of the loop (P) and then the second sensor 22e to the right of the middle sensor 22c takes over (FIG. 12).

In case of a wedding for example, the newly wed, boarding the cart 10, are thus given the opportunity to be present at least once across each guest as the guests seat at their respective table 30, and the newly wed are thus given the opportunity to interact with each one of their guest as the cart goes by along its path (P).

The black line running on the floor along the path (P) may be replaced by a reflective tape for example, the sensors 22 then being photoelectrical sensors. Alternatively, a magnetic tape may be used, the sensors 22 then being magnetic sensors.

The number of sensors 22 may be adjusted so as to achieve a desired steering smoothness depending on curvatures of the path (P).

The speed of the cart 10 may be adjusted depending on the total length of the path (P) to be travelled, so that the cart 10 achieves the whole path in a predetermined time for example. Moreover, the speed of the cart 10 may be varied along the path (P), so as to move quickly in parts of the path (P) of less interest or devoid of positions 30 (see for example (P₀) in FIG. 2).

The cart 10 may be automatically guided along the path (P) at a speed that can be preset, so that the cart 10 passes all positions, materialized by tables 30 in the examples discussed herein, along the path (P).

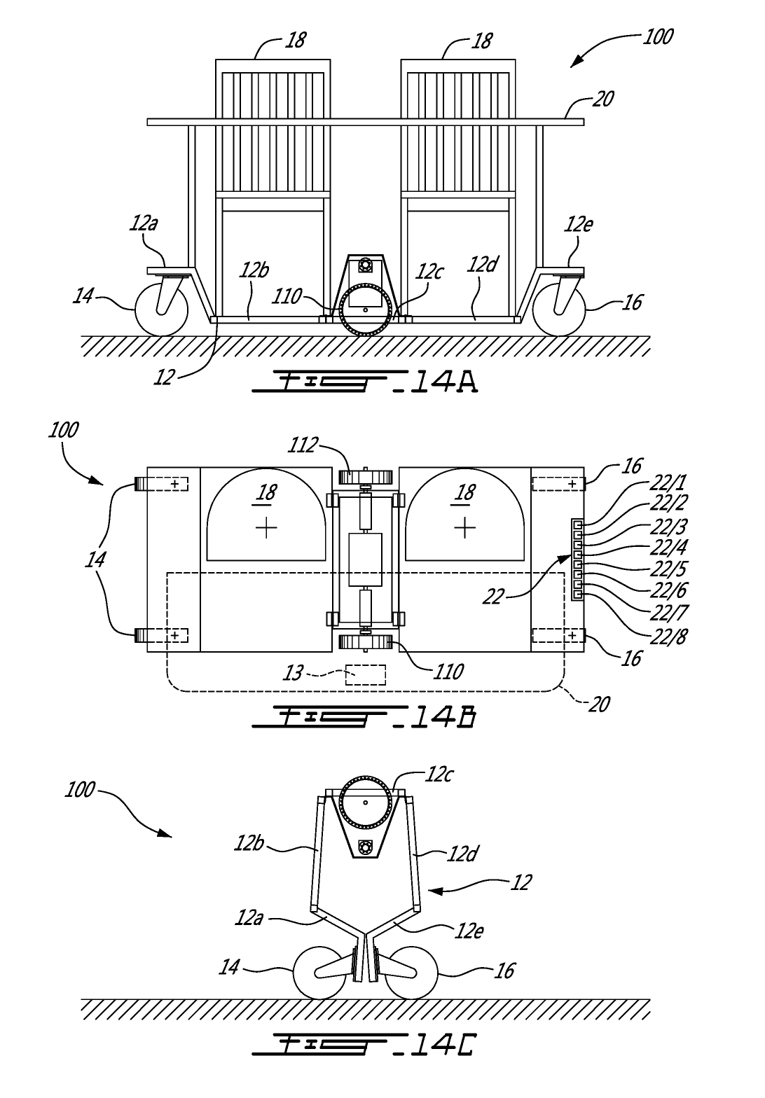

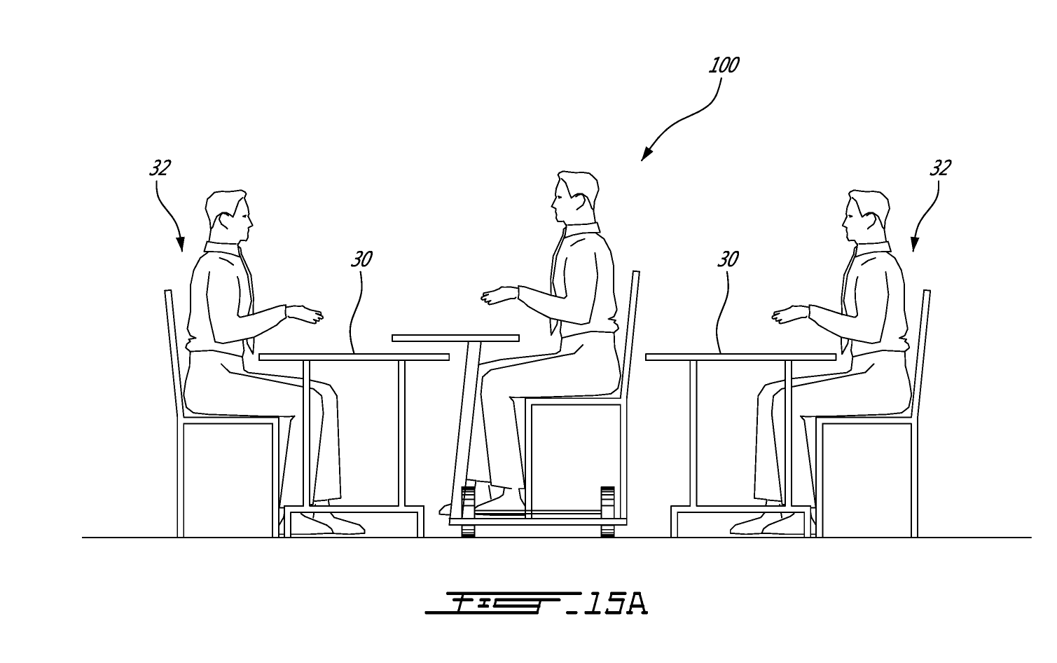

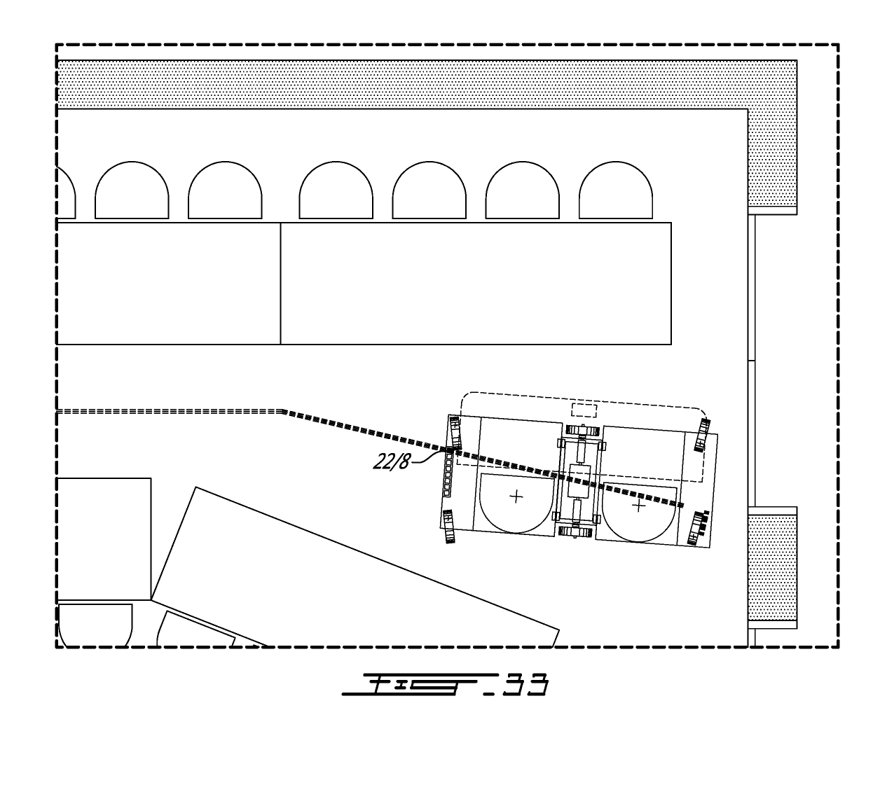

An embodiment will now be discussed in relation to FIGS. 14 to 36.

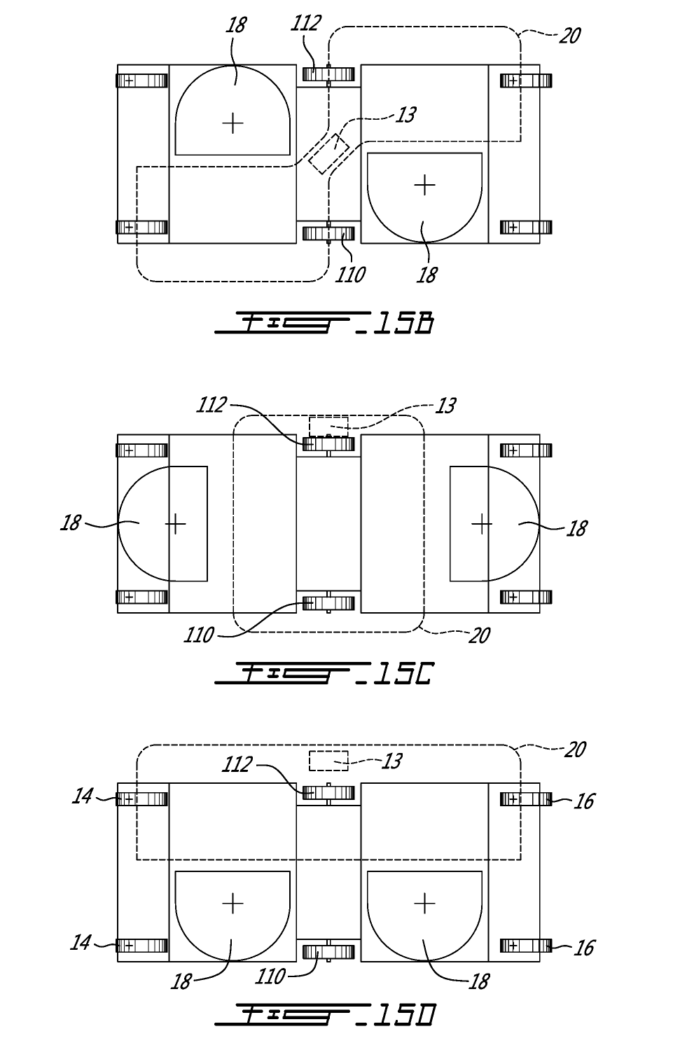

As illustrated in FIGS. 14 and 15, the platform 12 of the cart 100 comprises, in a six wheel configuration, middle wheels 110, 112 controlled by the controller 13, the front wheels 16 and the rear wheels 14 being free wheels supporting the platform.

In the illustrated embodiment, the platform 12 supports two seats 18 in front of a table 20. As shown in FIGS. 15B-15D, the seats 18 may be positioned side by side (FIG. 15D), or facing each other along the longitudinal axis of the cart (FIG. 15C), or in a diagonal (FIG. 15B).

The platform 12 may comprise connected parts 12a-12e so as to be foldable, once the table 20 and chairs 18 are removed, as shown in FIG. 14C.

The line of sensors 22 at the front edge of the platform 12 comprises a number of IR sensors 22/1-22/8, and the path (P) is marked on the ground using tape contrasting with the color of the ground surface, for example black or white tape, as will be discussed hereinbelow.

FIG. 16 illustrates a layout of a system according to an embodiment of an aspect of the present invention, with path (P).

FIGS. 18-25 illustrate the cart of FIG. 14 going along a path shown in the left top side corner of FIG. 16, i. e. when the cart 100 is to be directed to turn left for example.

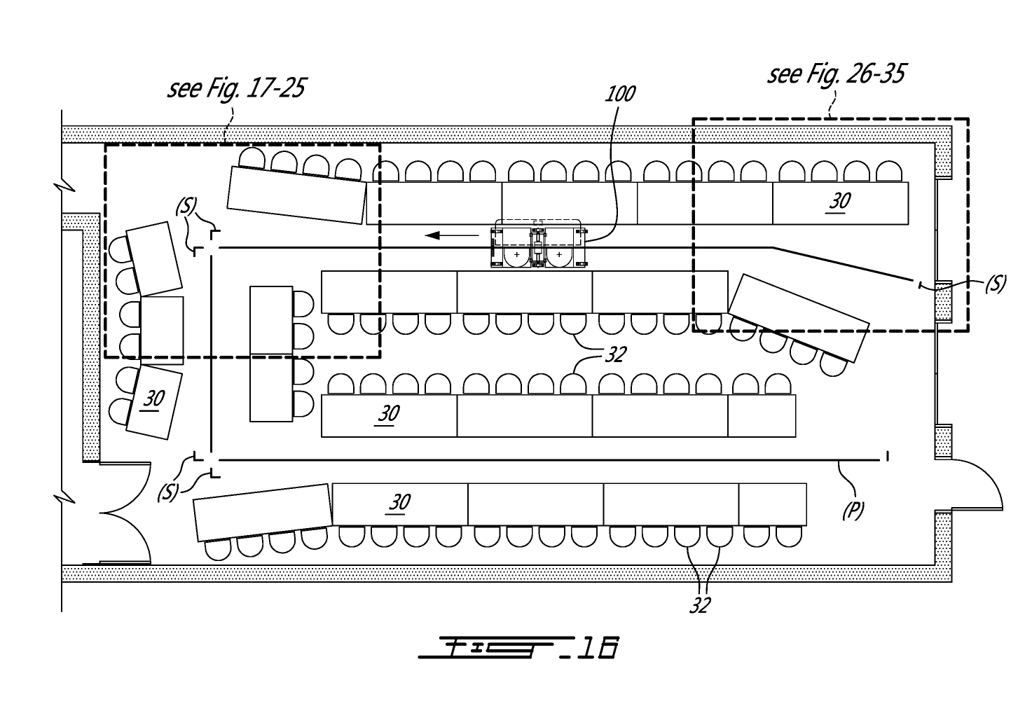

As shown in FIG. 18, when the path (P) is a straight line, the middle sensors 22/4 and 22/5 are activated; as a result the controller 13 activates both wheels 110 and 112 with the same forward speed, as indicated in the table of activation of the sensors of FIG. 36, so that the cart 100 follows a straight line. When an interruption (I) occurs on the path (P), signaling an upcoming turning part of the path (P), none of the sensors 22 are activated, i.e. there is a blank state, i. e. the controller 13 does not modify the speed of any of the wheels, so that the cart 100 keeps moving as last instructed, i.e. here straight ahead, until a signal (S) marked on the ground activates sensors 22/1 to 22/5 for example, as shown in FIG. 20, with the result that the controller 13 drives the left middle wheel 112 backwards at a reduced speed while driving the right middle wheel 110 forward at the same reduced speed (see FIG. 36, second to last row), thereby causing the cart 100 to turn to the left, until none of the sensors 22 are activated (see FIG. 21), the cart 100 still turning, and sensor 22/1 is activated by the path (P) (see FIG. 22), at which time the controller 13 activates both middle wheels forwards at different speeds (see first row of the table of FIG. 36), then sensors 22/2 and 22/3 (see FIG. 23 and fourth row of the table of FIG. 36), then sensor 22/4 (FIGS. 24 and 7th row of the table of FIG. 36), and finally middle sensors 22/4 and 22/5 are activated again, so that the controller 13 directs the cart 100 along the straight path (P) (see FIG. 25, 8th row of the table of FIG. 36). FIG. 17 shows the successive positions of the cart 100 along this exemplary portion of path.

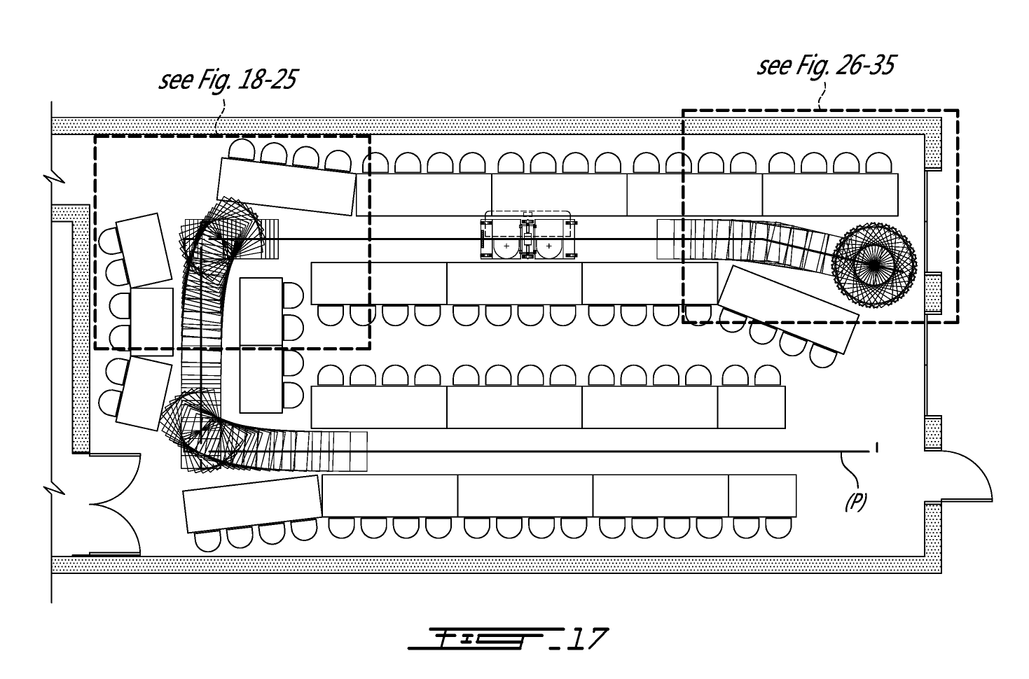

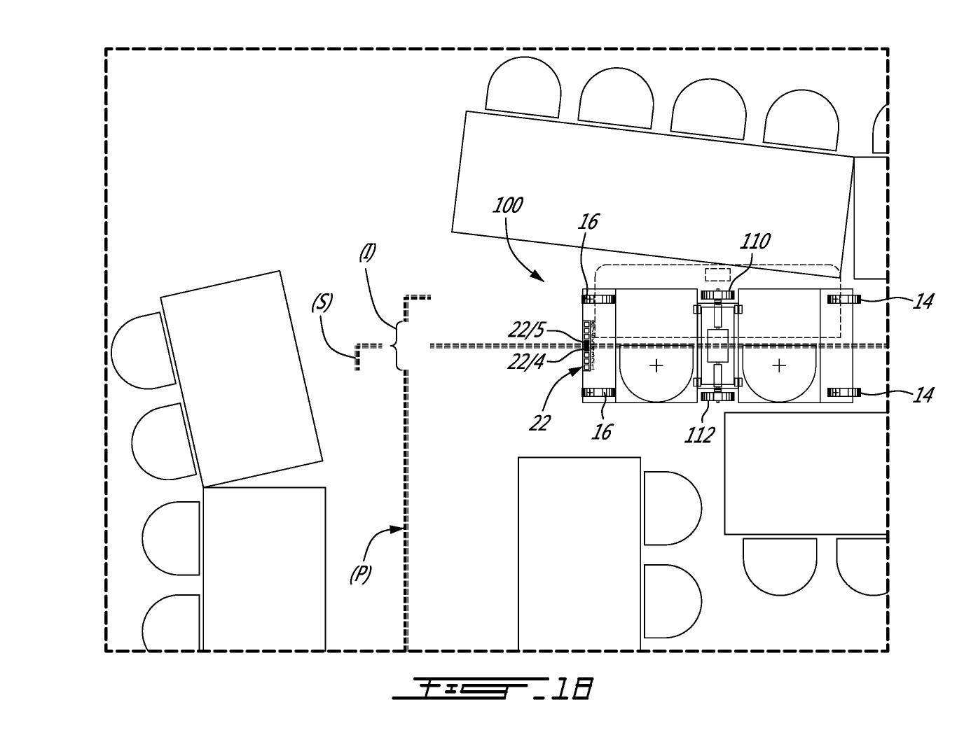

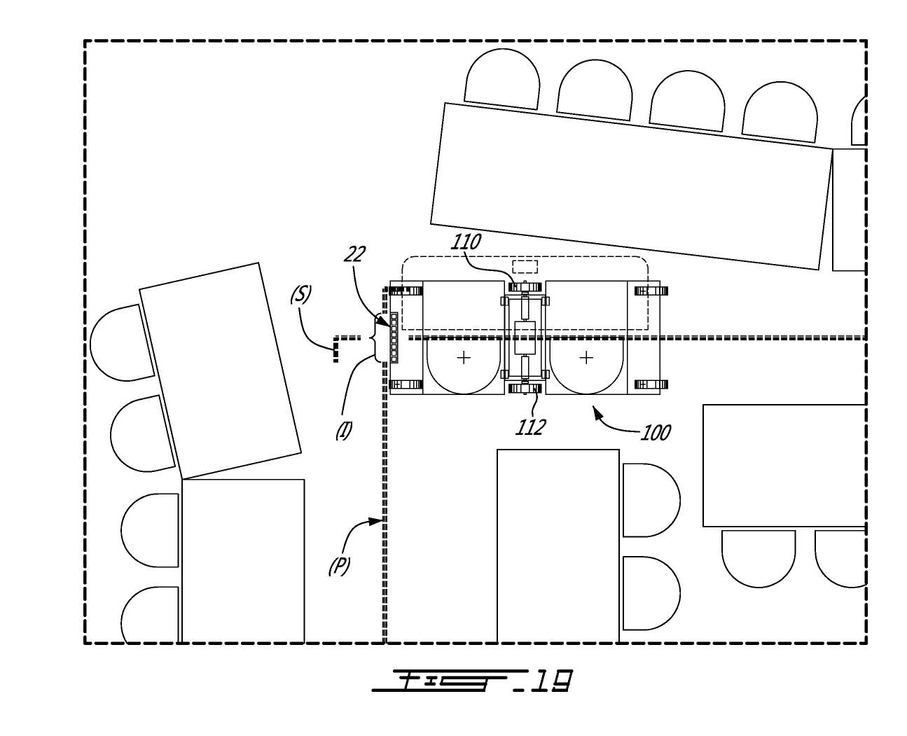

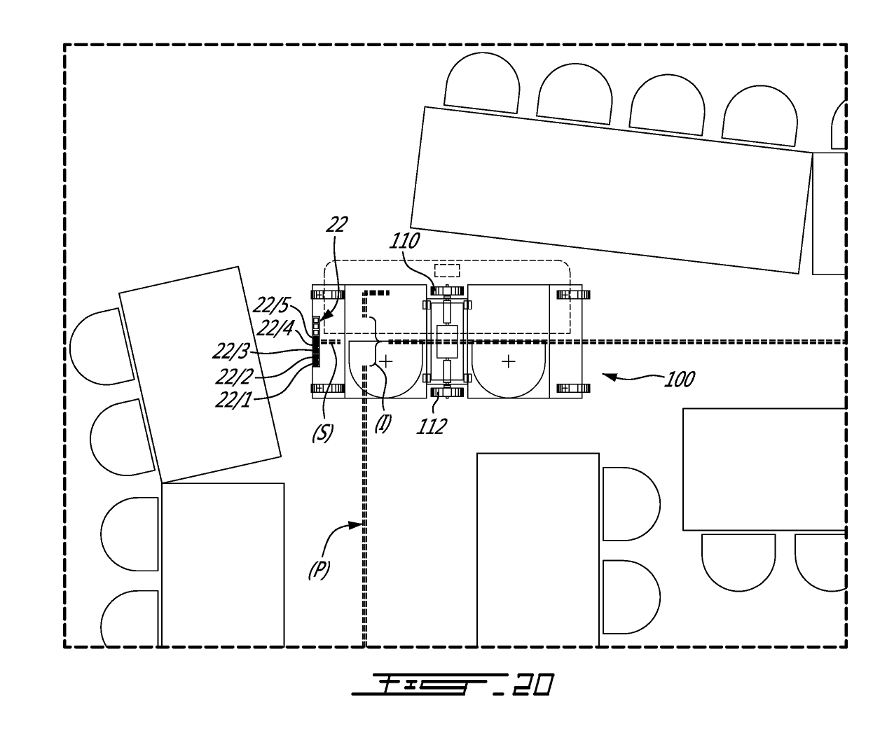

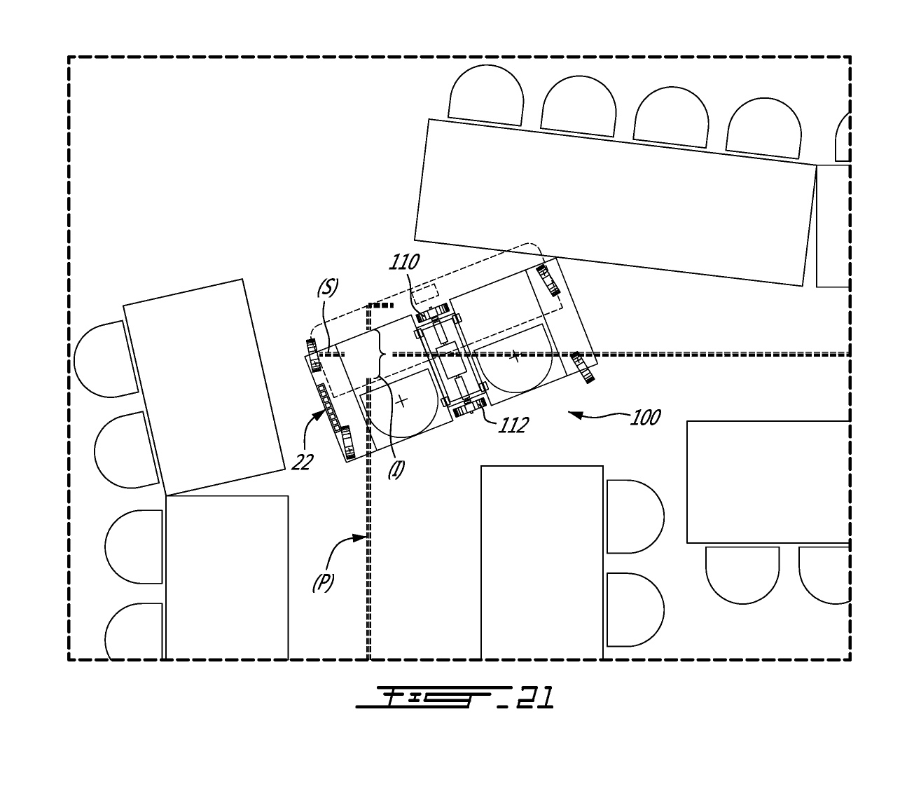

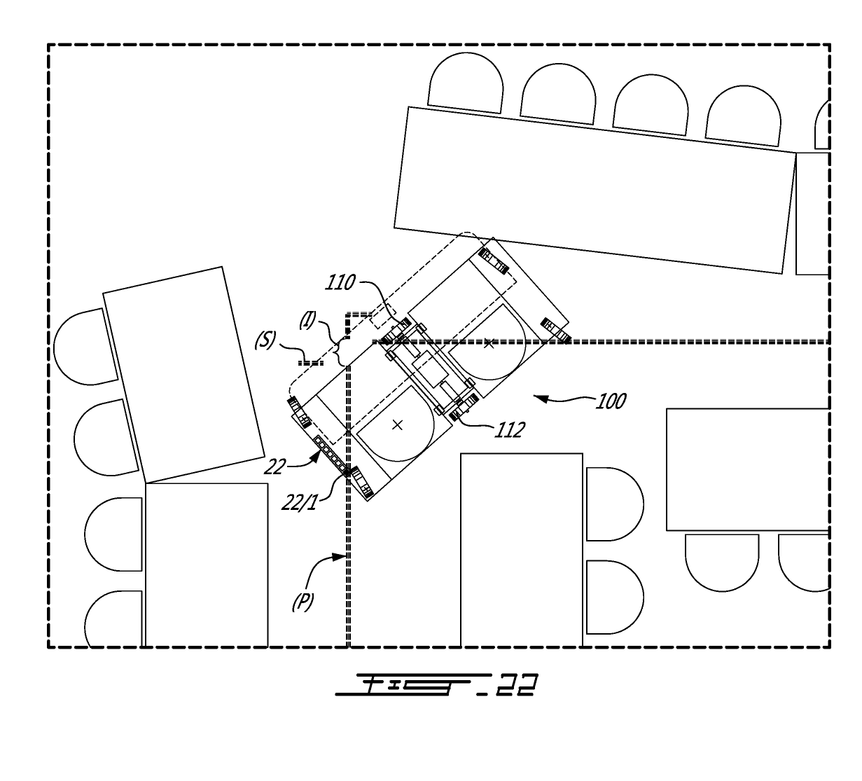

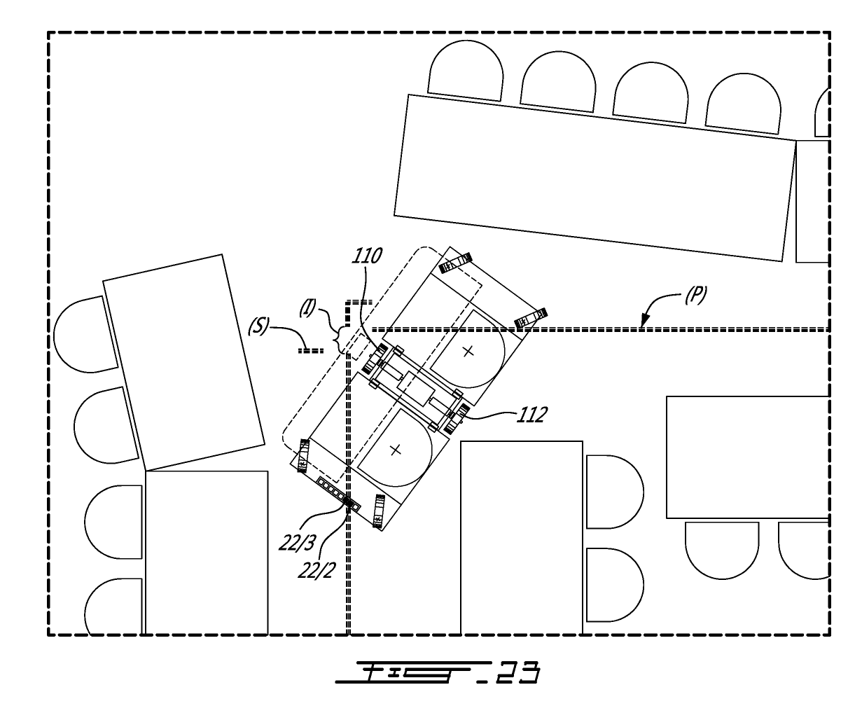

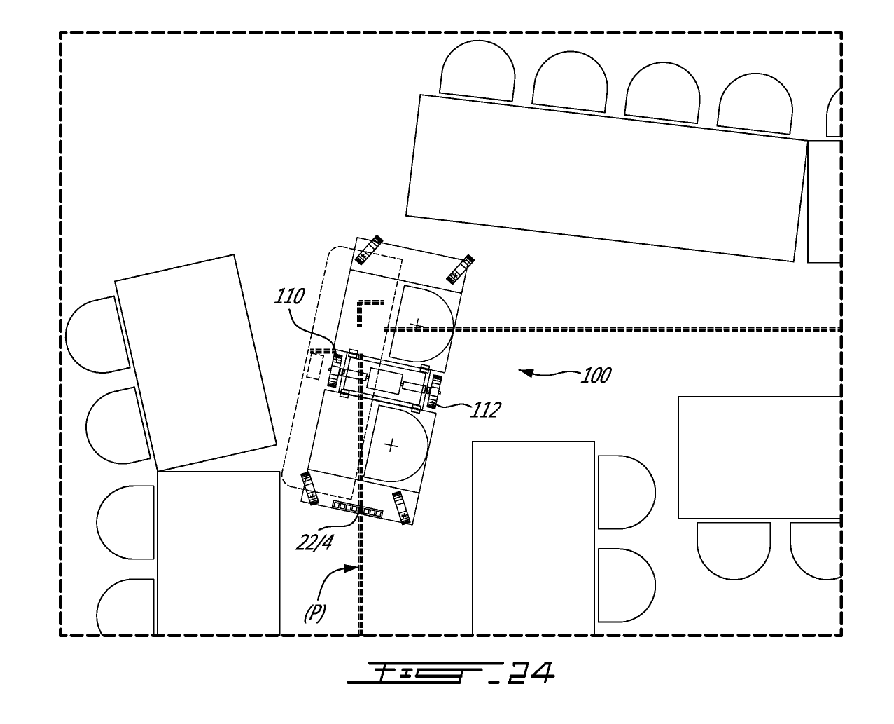

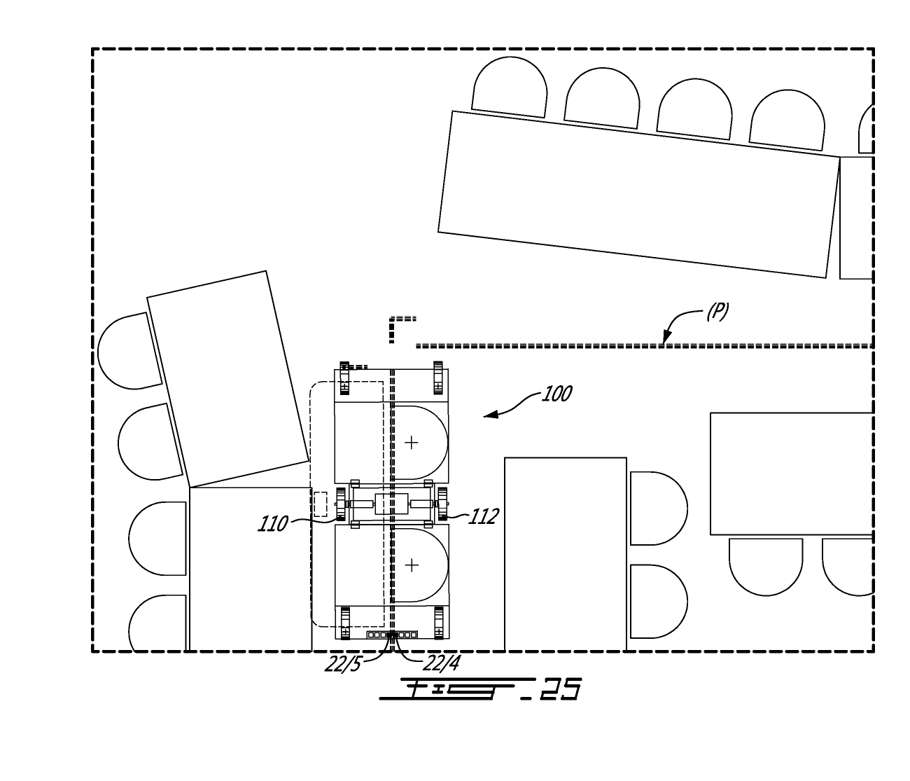

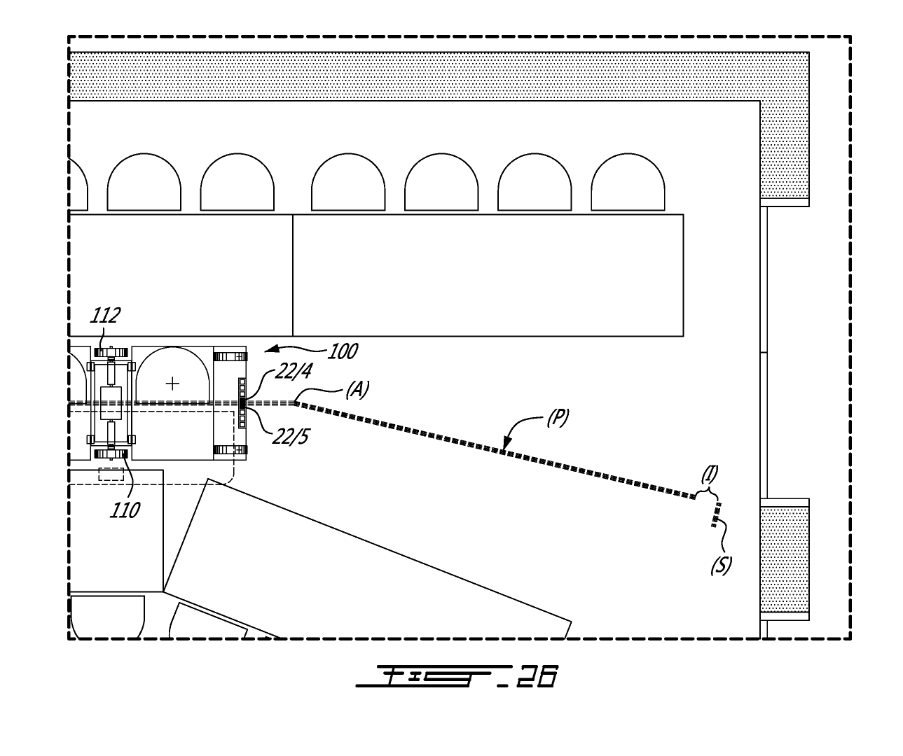

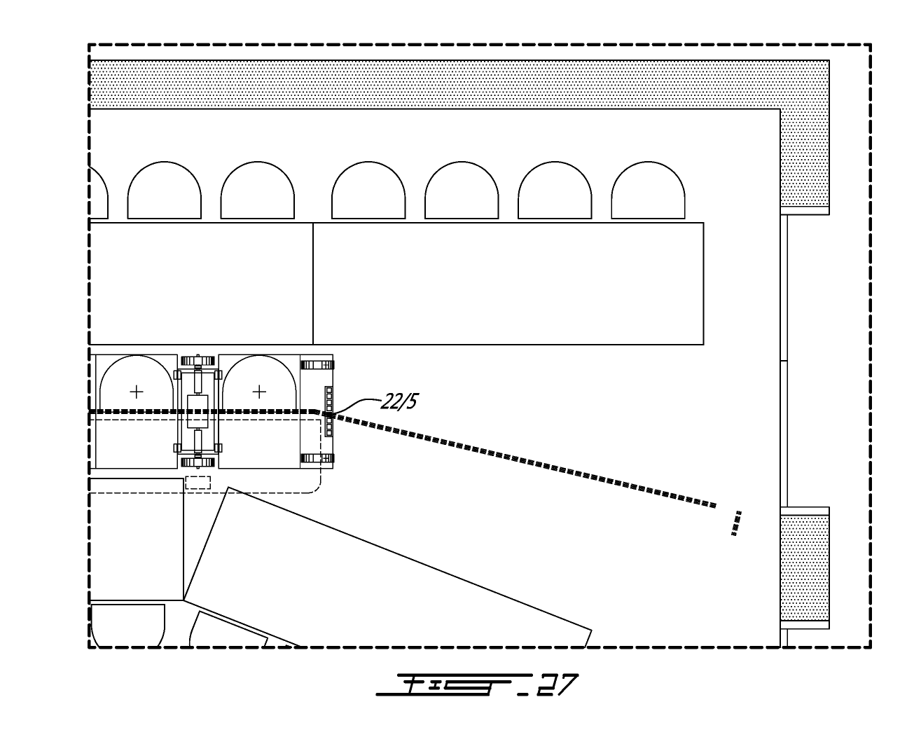

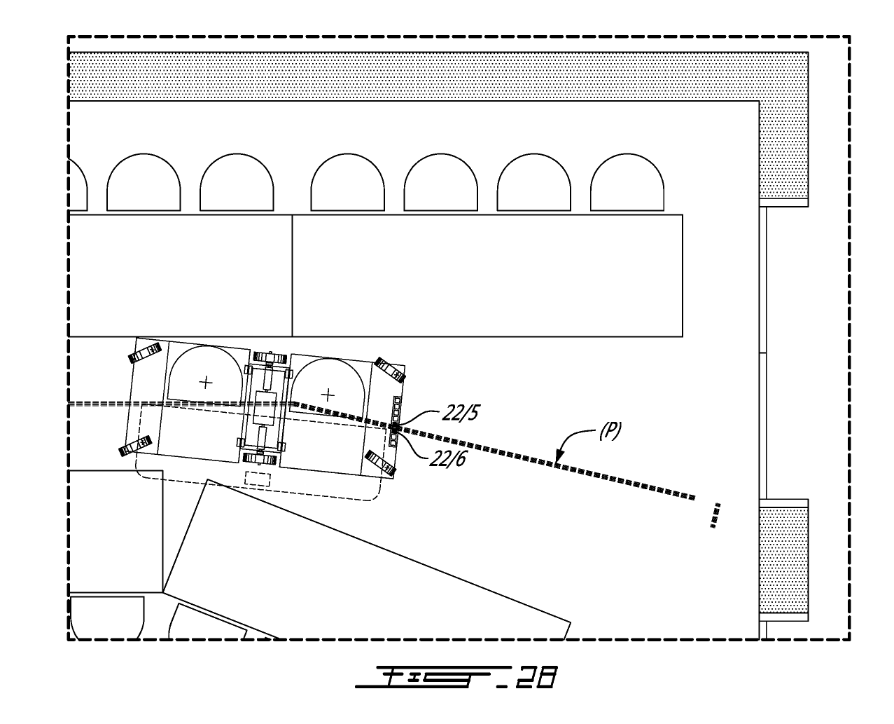

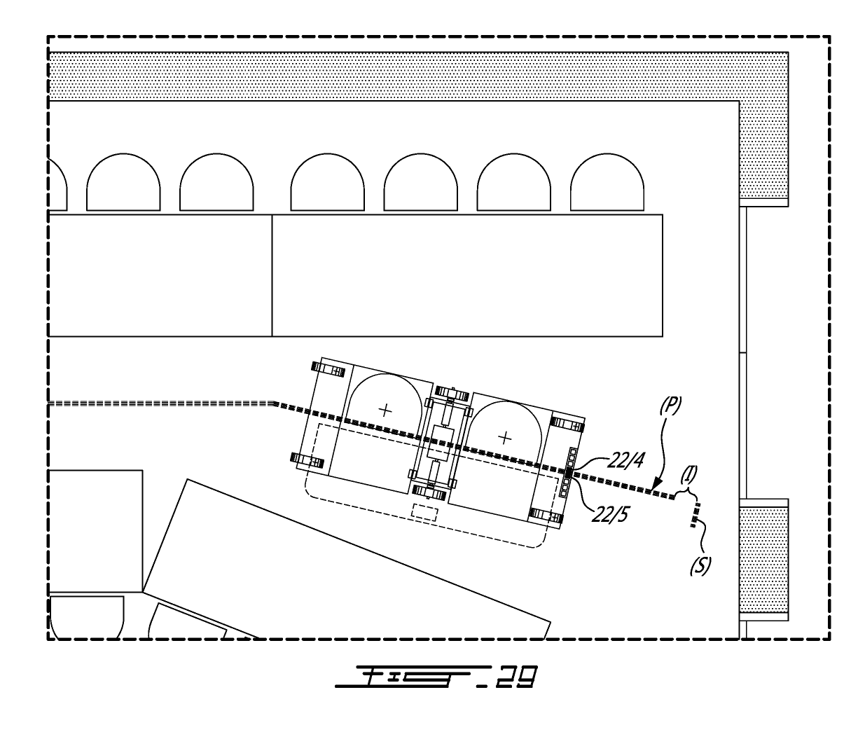

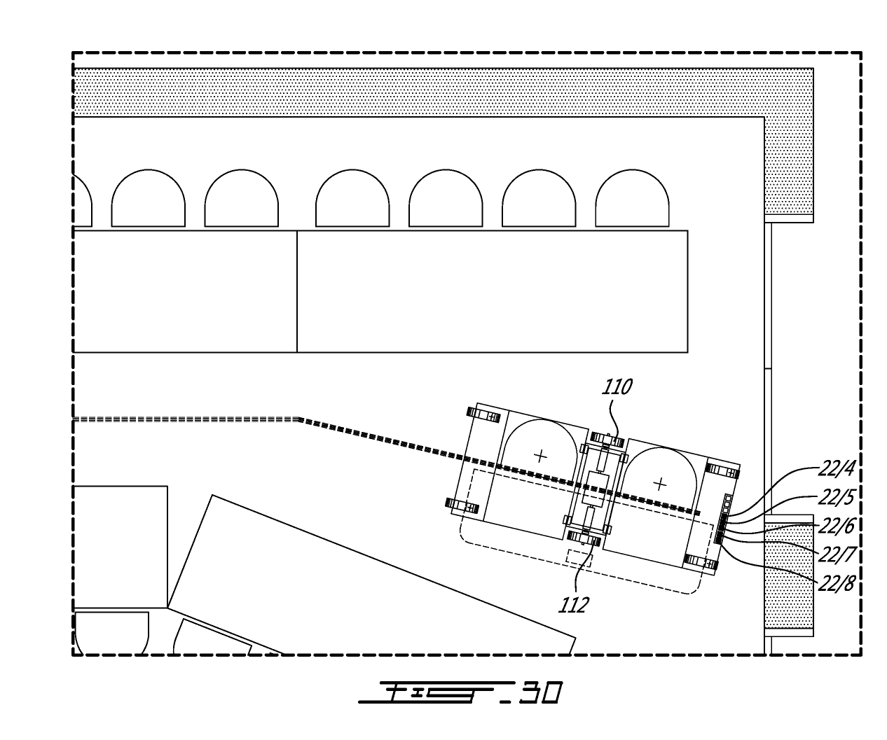

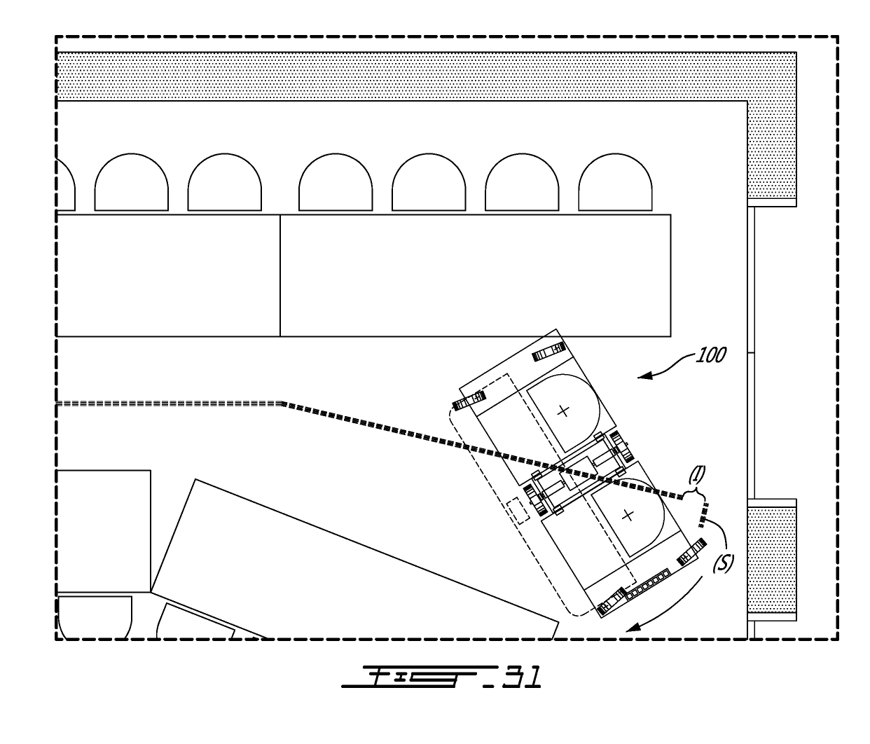

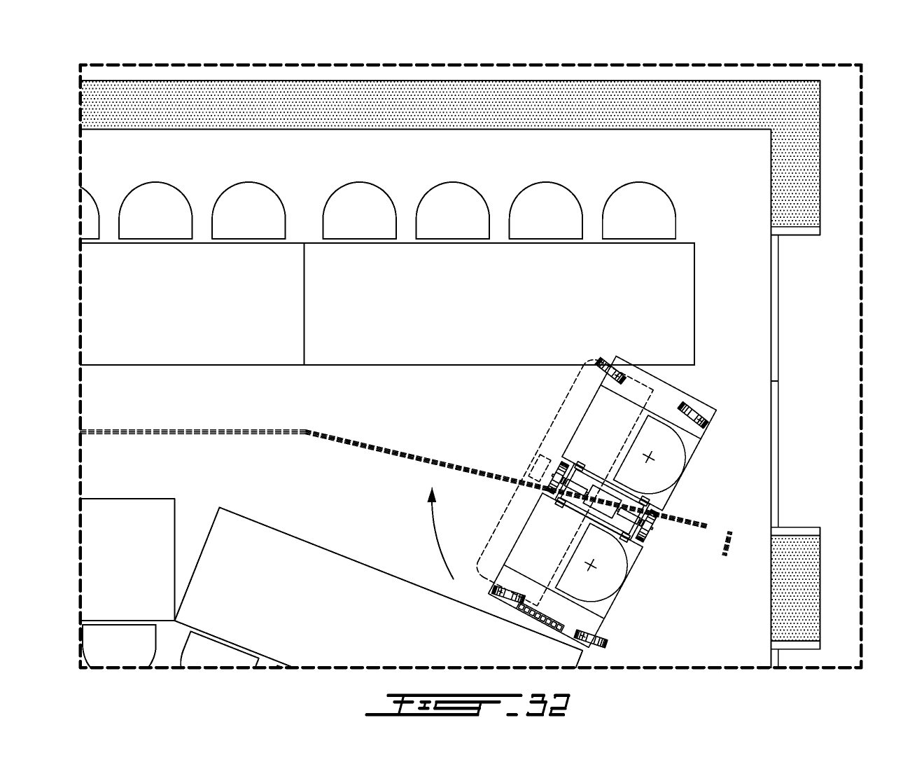

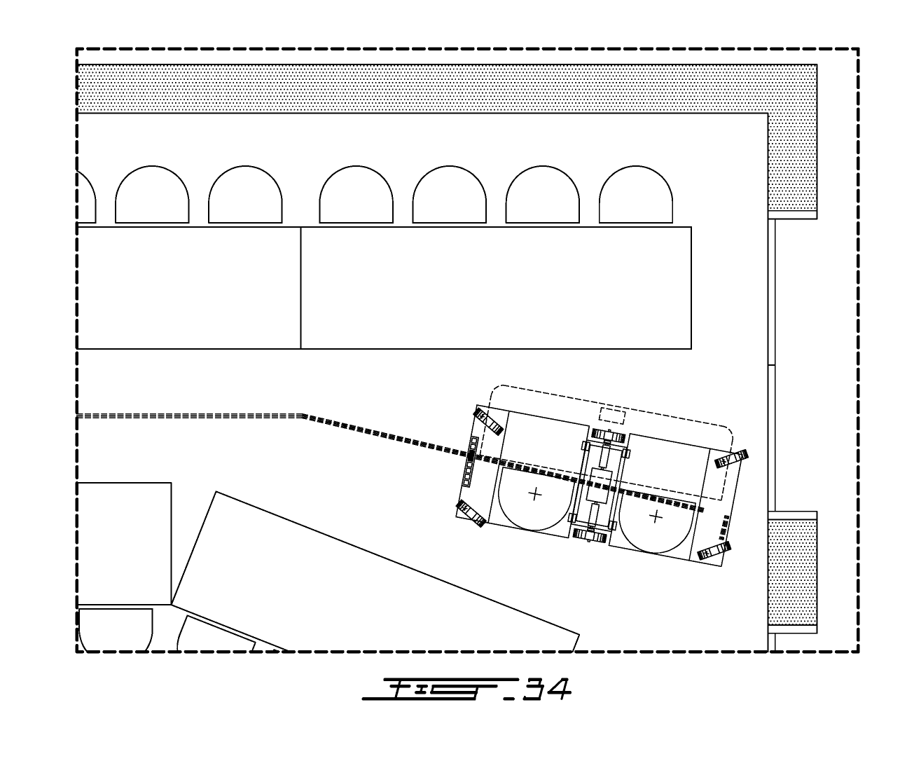

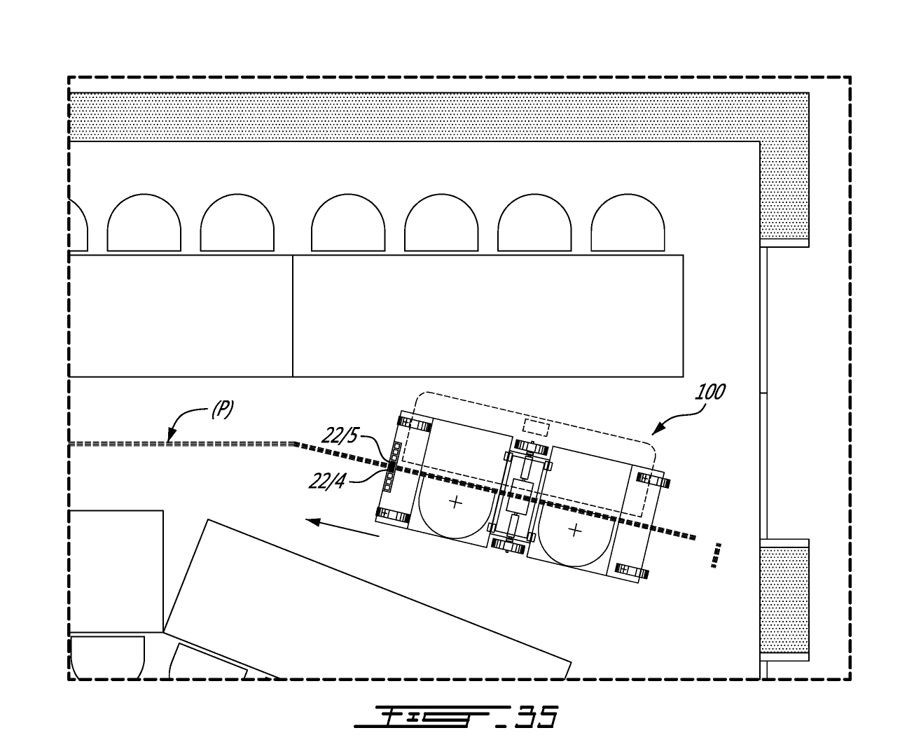

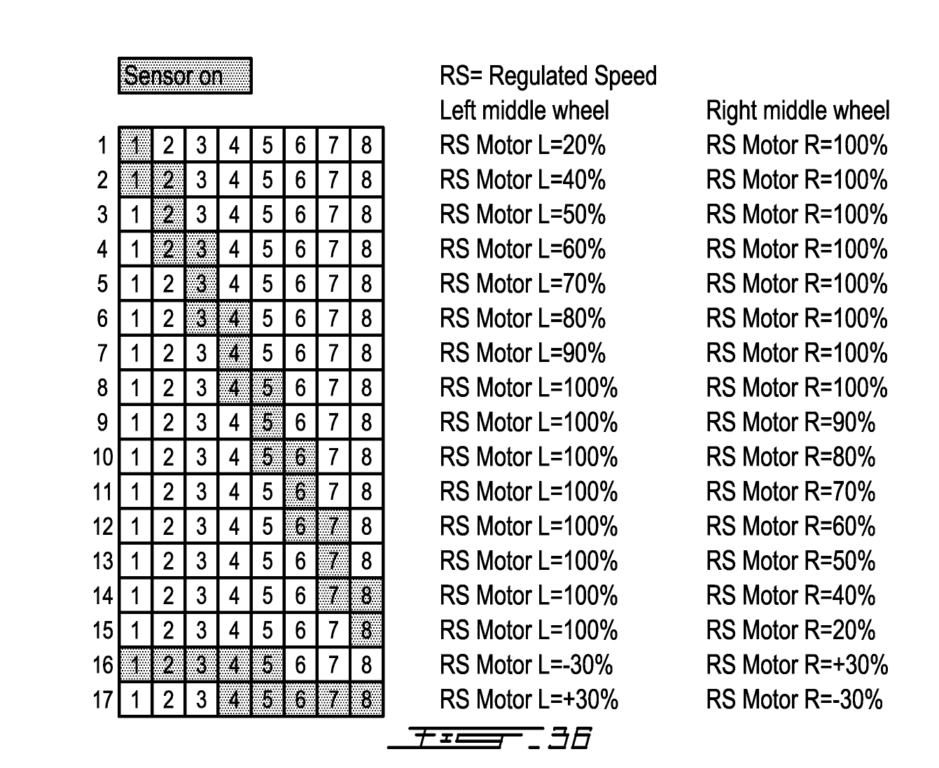

FIGS. 26-35 illustrate the cart of FIG. 14 going along another path shown in the right top side corner of FIG. 16. In FIG. 26, the cart 100 is shown travelling along a straight part of the path (P), as the middle sensors 22/4 and 22/5 are activated by the marking on the ground. As an angle (A) occurs on the path (P), only sensor 22/5 is activated (FIGS. 27 and 9th row of the table of FIG. 36), then two sensors 22/3 and 22/4 are activated (FIG. 28), so that the controller 13 prompts the cart 100 to the right, until the two middle sensors 22/4 and 22/5 are activated again by a straight portion of path again (FIG. 29). An interruption (I) in the path puts the sensors 22 in a blank state, until reaching a signal (S) activating sensors 22/4-22/8 as shown for example in FIG. 30, at which time the controller 13 prompts rotation of the right middle wheel 110 backwards at a reduced speed and the left middle wheel 112 forwards at the same reduced speed (see second to last line of the table of FIG. 36), thereby directing the cart 100 to rotate to the right (see FIGS. 31-33) until sensor 22/8 is activated upon hitting a portion of the path (P) again (FIG. 33), then two sensors 22/5 and 22/6 (FIG. 34) and then the two middle sensors 22/4 and 22/5 (FIG. 35) again, thereby redirecting the cart 100 along a straight path. FIG. 17 shows the imprint of the successive movements of the cart along this exemplary path.

Such embodiment using independently controlled middle wheels and IR sensors is found to allow a prompt and precise response of the cart to changes in the direction of the path, with a minimised space required around the cart for allowing the cart to turn to adjust to these changes of direction of the path (see FIGS. 18-25) or to do a U-turn (see FIGS. 26 to 35).

The cart may be provided with a brake for emergency stopping for example. The speed of the cart may be varied, for example from 1 m/min to 5 m/min, using a control box located at the center of the table on the platform for example.

The combination of a guiding system including wheels and sensors, and path laid on the ground may be replaced by a track laid on the ground to form the path (P) and a sensing pin on the cart detecting curvatures of the track, and physically guiding the cart therealong.

The combination of a guiding system and path laid on the ground may be replaced by a visual detection of the path, i.e. by eyes of a person aboard the cart for example, and manual guiding of the cart therealong, by this person aboard the cart for example.

In case of a space such as a garden lawn or a sandy beach side for example, the path (P) may be embodied by a tubing laid thereon for example and the sensors may be cameras detecting the form thus laid on the ground.

The cart was described as supporting at least one seat and a table for example. It may further support side service trays for example, or only support standing or seated people.

Other than weddings as described herein above for purpose of illustration, examples of applications are: testimonial dinners, meetings, parties, dating events, speed dating events using several of the carts of the present invention etc. . . . .

A method according to an embodiment of an aspect of the present invention comprises setting positions along a path, laying markers along the path, and guiding a cart with sensors reacting to the markers along the path.

The scope of the claims should not be limited by the embodiments set forth in the examples, but should be given the broadest interpretation consistent with the description as a whole.

1. A cart, comprising:
a platform;
a guiding unit including sensors being configured to detect a path materialised in a space; and
a controller;
wherein said controller sets a direction of the cart by acting on said cart in response to signals from said sensors.

2. The cart of claim 1, wherein said path is materialised along predetermined positions, said cart successively facing said positions as they cart is activated into moving along said path by said controller.

3. The cart of claim 1, wherein said guiding unit comprises front wheels provided with a deviation system, said controller controlling a speed and rotation direction of said front wheels via said deviation system.

4. The cart of claim 1, wherein said guiding unit comprises front wheels provided with a deviation system, said controller controlling a speed and rotation direction of said front wheels via said deviation system, said sensors are arranged in a line; and
wherein:
when said path follows a straight line, a center sensor of said line detects said path and sends a first signal to said controller, said controller receiving said first signal and activating said cart into a straight line via said deviation system;
when said path departs from the straight line, a sensor located on either side of the center sensor on said line detects said path and sends a second signal to said controller, said controller receiving said second signal and activating said cart into turning via said deviation system.

5. The cart of claim 1, wherein said guiding unit comprises motorised middle wheels, said controller controlling a speed and rotation direction of said middle wheels.

6. The cart of claim 1, wherein said guiding unit comprises motorised middle wheels, said controller controlling a speed and rotation direction of said middle wheels and said sensors are positioned in a line, and wherein:
when said path follows a straight line, a center sensor of said line detects said path and sends a first signal to said controller, said controller receiving said first signal and activating said cart into a straight line by setting a same first speed for both motorised wheels; and
when said path departs from the straight line, a sensor located on either side of the center sensor detects said path and sends a second signal to said controller, said controller receiving said second signal and activating said cart into turning by setting a second speed for a first one of the motorised wheels and a third speed for a second one of the motorised wheels.

7. The cart of any one of claim 1, wherein said platform is adapted to support at least one person.

8. The cart of any one of claim 1, wherein said platform supports at least one seat.

9. The cart of any one of claim 1, wherein said path is materialised by a line, said sensors being cameras, said cameras detecting said line.

10. The cart of any one of claim 1, wherein said path is materialised by a reflective tape, said sensors being photoelectrical sensors, said photoelectrical sensors detecting said reflective tape.

11. The cart of any one of claim 1, wherein said path is materialised by a contrasting tape, said sensors being infra-red sensors, said infra-red sensors detecting said contrasting tape.

12. The cart of any one of claim 1, wherein said path is materialised by a magnetic tape, said sensors being magnetic sensors, said magnetic sensors detecting said magnetic tape.

13. The cart of any one of claim 1, wherein said path is materialised by a tubing, said sensors being cameras, said cameras detecting said tubing.

14. The cart of any one of claim 1, wherein said path is materialised by a track, said sensors being integrated pins.

15. A combination, comprising a cart, a controller, and a guiding unit;
wherein said guiding unit comprises sensors configured to detect a path laid in a space along a succession of positions; and
wherein said controller sets a direction of the cart by acting on said guiding unit in response to signals from said sensors as the cart moves along said path.

16. A method for people interaction, comprising:
setting positions in a space;
materializing a path along the positions; and
guiding a mobile platform along the path.
